(19) United States
(12) Patent Application Publication
(10) Pub. No.: US 2014/0305210 A1
(43) Pub. Date: Oct. 16, 2014

(54) METHOD AND SYSTEM FOR AN EXERCISE APPARATUS WITH ELECTRONIC CONNECTORS

(71) Applicant: FITBUG LTD., London (GB)

(72) Inventors: Paul Landau, London (GB); Danny Ogen, London (GB)

(73) Assignee: FITBUG LTD., London (GB)

(21) Appl. No.: 14/148,702

(22) Filed: Jan. 6, 2014

Related U.S. Application Data
(60) Provisional application No. 61/748,866, filed on Jan. 4, 2013.

(51) Int. Cl. G01P 1/02; G01P 15/02

(52) U.S. Cl. CPC G01P 1/023; G01P 15/02
USPC 73/514.01

(57) ABSTRACT

Exemplary embodiments of a method and system of an exercise apparatus are provided where an exercise apparatus can be configured to work with multiple accessories, such as wrist bands, waist bands, clips, etc. The exercise apparatus can comprise an instrument sensor for recording exercise data pertaining to a user's physical activity, and one or more electrical connectors for connecting to an accessory, the one or more electrical connectors providing the exercise data to the accessory. The electrical connectors can also provide power to the accessory for a display on the accessory and/or other functions on the accessory.

### CROSS-REFERENCE TO RELATED APPLICATIONS

This application relates to and claims priority from U.S. patent application Ser. No. 61/748,866 filed Jan. 4, 2013, the entire disclosure of which is hereby incorporated herein by reference.

### FIELD OF THE DISCLOSURE

The present disclosure relates to exemplary embodiments of methods and systems for providing an exercise apparatus, and more particularly, to exemplary embodiments of methods and systems for providing an exercise status with electronic connectors.

### BACKGROUND INFORMATION

Many users who walk/jog and use exercise apparatuses to record their walking/jogging rate have difficulty wearing these device, which are generally stored in pockets, clipped to a waist band, or have to be wrapped around a body part, such as in a wrist/arm band or around the ankle.

It would be useful for users to be able to wear such exercise apparatuses without worrying about the device falling or dropping, and be able to choose the most appropriate mode of “wearing” the exercise apparatus while still allowing the ability to read the exercise data from the exercise apparatus.

### SUMMARY OF EXEMPLARY EMBODIMENTS OF THE DISCLOSURE

At least some of the above described problems can be addressed by exemplary embodiments of the methods and systems according to the present disclosure. For example, using such exemplary embodiments, it is possible to provide methods and systems that provide for an exercise apparatus that can be configured to work with multiple accessories, such as wrist bands, waist bands, clips, etc. The exercise apparatus can have electrical connectors that connect with the accessory, and provide data from the exercise apparatus to the accessory to be displayed on the accessory.

The present disclosure describes exemplary embodiments of methods and systems that can provide an exercise apparatus comprising an instrument sensor for recording exercise data pertaining to a user's physical activity, and one or more electrical connectors for connecting to an accessory, the one or more electrical connectors providing the exercise data to the accessory.

The exercise apparatus can further comprise a front case and a rear case. The instrument can be an accelerometer. The exercise apparatus can further comprise a wireless transceiver for streaming the exercise data to the accessory in real time. The one or more electrical connectors can provide power for the accessory once the exercise apparatus is connected to the accessory using the electrical connectors. The accessory can be one of a watch, wrist band, belt clip and underwear clip.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of an exercise apparatus according to an exemplary embodiment of the present disclosure;

FIG. 2 is an illustration of an exercise apparatus in combination with a wristband having an LED display according to an exemplary embodiment of the present disclosure;

FIG. 3 is an illustration of an exercise apparatus in combination with a wristband having an LCD display according to an exemplary embodiment of the present disclosure;

FIG. 4 is an illustration of an exercise apparatus in combination with a belt clip according to an exemplary embodiment of the present disclosure; and

FIG. 5 is an illustration of an exercise apparatus in combination with an underwear clip according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the methods and systems of the present disclosure will now be described with reference to the figures.

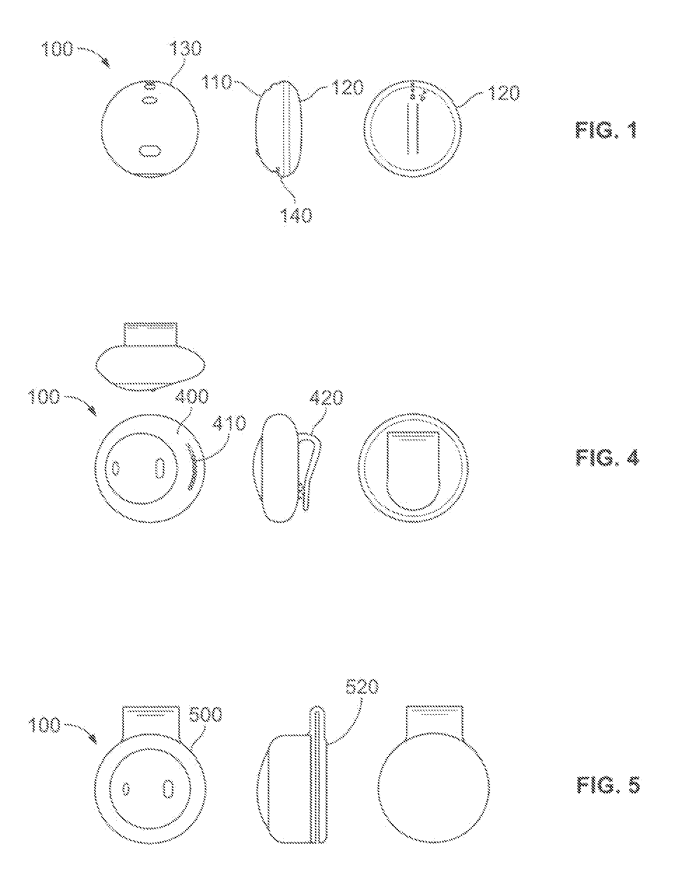

FIG. 1 is an illustration of an exercise apparatus 100 according to an exemplary embodiment of the present disclosure. The exercise apparatus 100 can have a front case 110, a rear case 120, a lanyard hole 130, one or more electrical connectors 140, and/or a battery door at the rear case 120. The exercise apparatus 100 can also have, e.g., a battery, a display, an instrument such as an accelerometer, a processor, integrated circuitry, a wireless transceiver (e.g., Bluetooth, ANT+, or other RF communication protocols), and/or storage for storing exercise data relating to one or more users (not shown). The instrument (e.g., accelerometer) in the exercise apparatus 100 can process activity data, such as but not limited to steps taken, calories burned, distance travelled, minutes of motion of the user, and other physical activity data of the user. Other instruments with similar functionality to accelerometers can also be incorporated. The electrical connectors 140 can connect to an accessory, and provide data from the exercise device 100 to the accessory. The electrical connectors 140 can also provide power for the accessory, or the accessory can have its own power source, or both. The communication between the exercise apparatus 100 and the accessory can be via the electrical connectors 140 or via wireless transceiver (e.g., Bluetooth, ANT+, or other RF communication protocols).

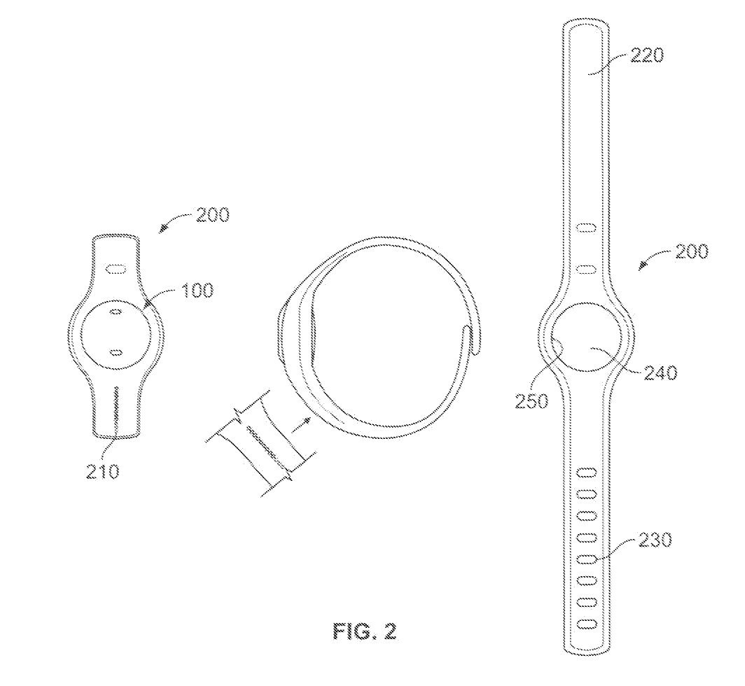

FIG. 2 is an illustration of an exercise apparatus in combination with a wristband having an LED display according to an exemplary embodiment of the present disclosure. A wristband 200 can be provided having a top strap 220 and a bottom strap 230. The exercise apparatus 100 can be provided within the recess 240 of the accessory 200. The electrical connectors 140 (e.g., male connectors) can connect with female connectors 250 along the recess 240 of the accessory 200. Once connected to the female connectors 250, the electrical connectors 140 can communicate with the accessory 200 to pass data to the accessory, and/or to power the accessory to display the activity data received from the exercise device 100, such as on display 210, which can be an LED display.

FIG. 3 is an illustration of an exercise apparatus in combination with a wristband having an LCD display according to an exemplary embodiment of the present disclosure. Here, the wristband 300 is similar to wristband 200, where the display is an LCD display 310. Data from the exercise apparatus (e.g., activity data) can be displayed on the LCD display.

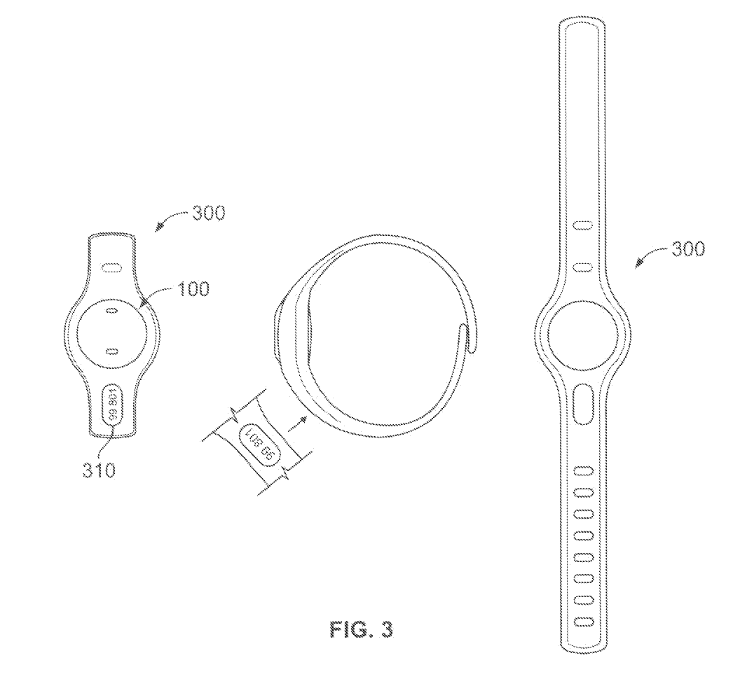

FIG. 4 is an illustration of an exercise apparatus in combination with a belt clip according to an exemplary embodiment of the present disclosure. A belt clip accessory 400 can be provided, having a clip 420 along the rear of the belt clip accessory 400, for attachment with a belt of a user, or other device. The male connectors 140 of the exercise apparatus 100 can connect with female connectors provided within the interior of the belt clip accessory 400, and provide data to a display 410, which can be an LED, LCD or other similar display.

FIG. 5 is an illustration of an exercise apparatus in combination with an underwear clip according to an exemplary embodiment of the present disclosure. An underwear clip accessory 500 can be provided, having a clip 520 along the rear of the underwear clip accessory 500, for attachment with an underwear of a user, or other clothing. The male connectors 140 of the exercise apparatus 100 can connect with female connectors provided within the interior of the underwear clip accessory 500.

Various other considerations can also be addressed in the exemplary applications described according to the exemplary embodiments of the present disclosure. The exemplary embodiments of the methods and systems described herein can provide, e.g., an exercise apparatus that can be worn with various different accessories, provide activity data to the accessory, and the accessory may not require any battery or external power as it can be powered by the exercise apparatus through the connection with the electronic connectors.

The exemplary embodiments of the present disclosure can be used in various configurations and in different systems. Various computing arrangements can be provided, and the exercise apparatus can have a processor(s) configured or programmed to perform the exemplary steps and/or procedures of the exemplary embodiments of the present disclosure described above. Various data described above can be stored in various storage arrangements (e.g., hard drive, memory device, such as RAM, ROM, memory stick, floppy drive, other tangible computer-accessible medium, etc.) in the exercise apparatus. The processor(s) can access the storage arrangement(s) to execute a computer program or a set of instructions (stored on or in the storage arrangement) which can perform the procedures according to the exemplary embodiments of the methods and systems of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. The disclosures of all documents and publications cited herein are hereby incorporated herein by reference in their entireties.

What is claimed is:

1. An exercise apparatus, comprising:
an instrument sensor for recording exercise data pertaining to a user's physical activity; and
one or more electrical connectors for connecting to an accessory, the one or more electrical connectors providing the exercise data to the accessory.

2. The exercise apparatus of claim 1, further comprising:
a front case; and
a rear case.

3. The exercise apparatus of claim 1, wherein the instrument is an accelerometer.

4. The exercise apparatus of claim 1, further comprising:
a wireless transceiver for streaming the exercise data to the accessory in real time.

5. The exercise apparatus of claim 1, wherein the one or more electrical connectors provide power for the accessory once the exercise apparatus is connected to the accessory using the electrical connectors.

6. The exercise apparatus of claim 1, wherein the accessory is one of a watch, wrist band, belt clip and underwear clip.
